(19) United States
(12) Patent Application Publication
(10) Pub. No.: US 2024/0209981 A1
(43) Pub. Date: Jun. 27, 2024

(54) TRENCH BOX OR PARAPET WALL GUARDRAIL RECEIVER

(71) Applicant: CHECKMATE LIFTING & SAFETY LTD, Kent (GB)

(72) Inventors: Luis E. Torrealba Martinez, Porter, TX (US); Warren L. Faber, Bonney Lake, WA (US)

(73) Assignee: CHECKMATE LIFTING & SAFETY LTD, Kent (GB)

(21) Appl. No.: 18/529,633

(22) Filed: Dec. 5, 2023

Related U.S. Application Data
(60) Provisional application No. 63/434,160, filed on Dec. 21, 2022.

(51) Int. Cl. F16M 13/02; E04G 21/32; E06C 7/50

(52) U.S. Cl. CPC F16M 13/022; E04G 21/3219; E06C 7/505

(57) ABSTRACT

A guardrail receiver comprises first and second base portions. The first base portion includes a first engaging portion and a first connecting portion, and the second base portion includes a second engaging portion and a second connecting portion. A female connector is operatively connected to one of the first base portion or the second base portion, and a male connector is operatively connected to one of the first base portion or the second base portion. The female and male connectors are configured and arranged to be operatively connected to a variety of safety devices selected from a group consisting of a guardrail leg and a ladder rail, wherein during use one of the female and male connectors is used with one of the guardrail leg or the ladder rail.

### CROSS-REFERENCE TO RELATED APPLICATIONS

This application claims the benefit of U.S. Provisional Patent Application Ser. No. 63/434,160, filed Dec. 21, 2022, which is incorporated by reference in its entirety herein.

### BACKGROUND

Fall protection equipment is commonly used to reduce a likelihood of a fall and/or serious injuries associated with a fall, particularly by users who perform tasks at heights or are at risk of falling. Guardrails are commonly used to provide a physical barrier between the user and the fall hazard. Guardrails are positioned proximate leading edges of fall hazards to prevent a user from going over the edges. Guardrails can be installed on a temporary or permanent basis. For example, a user performing tasks proximate a top of a trench box or parapet wall is at risk of falling off the trench box or parapet wall. A guardrail receiver, to which a guardrail is operatively connected, provides fall protection. Although not needed in every situation, a safety harness donned by the user and connected via a lanyard to an anchor could be used to supplement the guardrail.

For the reasons stated above and for other reasons stated below, which will become apparent to those skilled in the art upon reading and understanding the present specification, there is a need in the art for an improved trench box or parapet wall guardrail receiver.

### SUMMARY

The above-mentioned problems associated with prior devices are addressed by embodiments of the disclosure and will be understood by reading and understanding the present specification. The following summary is made by way of example and not by way of limitation. It is merely provided to aid in understanding some of the aspects of the invention.

In one embodiment, a guardrail receiver is configured and arranged for use with a trench box or parapet wall having sides defining a width. The guardrail receiver comprises first and second base portions slidably operatively connected to a desired position to accommodate the width of the trench box or parapet wall. The first base portion includes a first engaging portion and a first connecting portion extending perpendicularly from each other. The second base portion includes a second engaging portion and a second connecting portion extending perpendicularly from each other. The first and second engaging portions are configured and arranged to engage the sides defining the width. A female connector is operatively connected to one of the first base portion or the second base portion, and a male connector is operatively connected to one of the first base portion or the second base portion. The female and male connectors are configured and arranged to be operatively connected to a variety of safety devices selected from a group consisting of a guardrail leg and a ladder rail, wherein during use one of the female and male connectors is used with one of the guardrail leg or the ladder rail.

In one embodiment, a guardrail receiver assembly is configured and arranged for use with a trench box or parapet wall including walls forming a corner, each wall having sides defining a width. The guardrail receiver assembly comprises first and second guardrail receivers. The first guardrail receiver comprises a first base and a first connector. The first base is configured and arranged to engage the sides of a first wall, and the first connector is operatively connected to the first base and is configured and arranged to be operatively connected to a first safety device selected from the group consisting of a first guardrail leg and a first ladder rail. The second guardrail receiver comprises a second base and a second connector. The second base is configured and arranged to engage the sides of a second wall, and the second connector is operatively connected to the second base and is configured and arranged to be operatively connected to a second safety device selected from the group consisting of a guardrail leg and a ladder rail. When the first and second guardrail receivers are configured and arranged to be positioned on adjacent walls proximate the corner, positioned approximately ninety degrees relative to each other, the first and second guardrail receivers are configured and arranged to form a corner gap of not more than 7.0 inches between outer, inwardly facing surfaces of portions of the first and second safety devices operatively connected to the first and second connectors.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. In accordance with common practice, the various described features are not drawn to scale but are drawn to emphasize specific features relevant to the present disclosure. Reference characters denote like elements throughout the Figures and the text.

FIG. 1 is an exploded perspective view of an embodiment guardrail receiver constructed in accordance with the principles of the present invention;

FIG. 2 is a perspective view of the guardrail receiver shown in FIG. 1;

FIG. 3 is a top view of the guardrail receiver shown in FIG. 1;

FIG. 4 is a cross section view of the guardrail receiver taken along the lines 4-4 in FIG. 3;

FIG. 5 is a side view of the guardrail receiver shown in FIG. 1 in a closed position;

FIG. 6 is a side view of the guardrail receiver shown in FIG. 1 in an open position;

FIG. 7 is a perspective view of a guardrail assembly operatively connected to a trench box or parapet wall including guardrail receivers shown in FIG. 1;

FIG. 8 is a partially exploded perspective view of another guardrail assembly to be operatively connected to a trench box or parapet wall including guardrail receivers shown in FIG. 1;

FIG. 9 is a perspective view of the guardrail assembly operatively connected to the trench box or parapet wall including guardrail receivers shown in FIG. 8 connected to posts of a guardrail;

FIG. 10 is a perspective view of the guardrail receiver connected to the trench box or parapet wall and a post of the guardrail shown in FIG. 9;

FIG. 11 is a perspective view of another guardrail assembly operatively connected to a trench box or parapet wall proximate a corner including guardrail receivers shown in FIG. 1;

FIG. 12 is a top view of the guardrail assembly shown in FIG. 11;

FIG. 13 is a perspective view of another guardrail assembly operatively connected to a trench box or parapet wall including the guardrail receiver shown in FIG. 1 to which a toe board is operatively connected;

FIG. 14 is a perspective view of a ladder assembly to be operatively connected to a trench box or parapet wall including guardrail receivers shown in FIG. 1; and

FIG. 15 is a perspective view of the ladder assembly operatively connected to the trench box or parapet wall including guardrail receivers shown in FIG. 14.

### DETAILED DESCRIPTION

In the following detailed description, reference is made to the accompanying drawings, which form a part hereof, and in which is shown by way of illustration embodiments in which the disclosure may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that other embodiments may be utilized and mechanical changes may be made without departing from the spirit and scope of the present disclosure. The following detailed description is, therefore, not to be taken in a limiting sense.

Embodiments of the disclosure generally provide a guardrail receiver for use with a trench box or parapet wall having sides defining a width. An example width can be 0.25 inch to 8.00 inches. It should be understood that the terms trench box and parapet wall used herein include any other similar structure to which a guardrail receiver can be operatively connected. The guardrail receiver includes a first base portion and a second base portion. The first base portion includes a first engaging portion and a first connecting portion extending perpendicularly from each other. The second base portion includes a second engaging portion and a second connecting portion extending perpendicularly from each other. The first and second connecting portions are slidably operatively connected to a desired position to accommodate the width of the trench box or parapet wall, and the first and second engaging portions are configured and arranged to engage the sides defining the width. A female connector is operatively connected to one of the first base portion or the second base portion, and a male connector is operatively connected to one of the first base portion or the second base portion. The female and male connectors are configured and arranged to be operatively connected to a variety of safety devices selected from a group consisting of a guardrail leg and a ladder rail. During use, one of the female and male connectors is used with one of the guardrail leg or the ladder rail. Optionally, a toe board connector is operatively connected to one of the first base portion or the second base portion. When the first and second guardrail receivers are positioned on adjacent walls proximate a corner, positioned approximately ninety degrees relative to each other, the first and second guardrail receivers configured and arranged to form a corner gap of preferably not more than 7.0 inches between outer, inwardly facing surfaces of portions of first and second safety devices operatively connected to the first and second guardrail receivers.

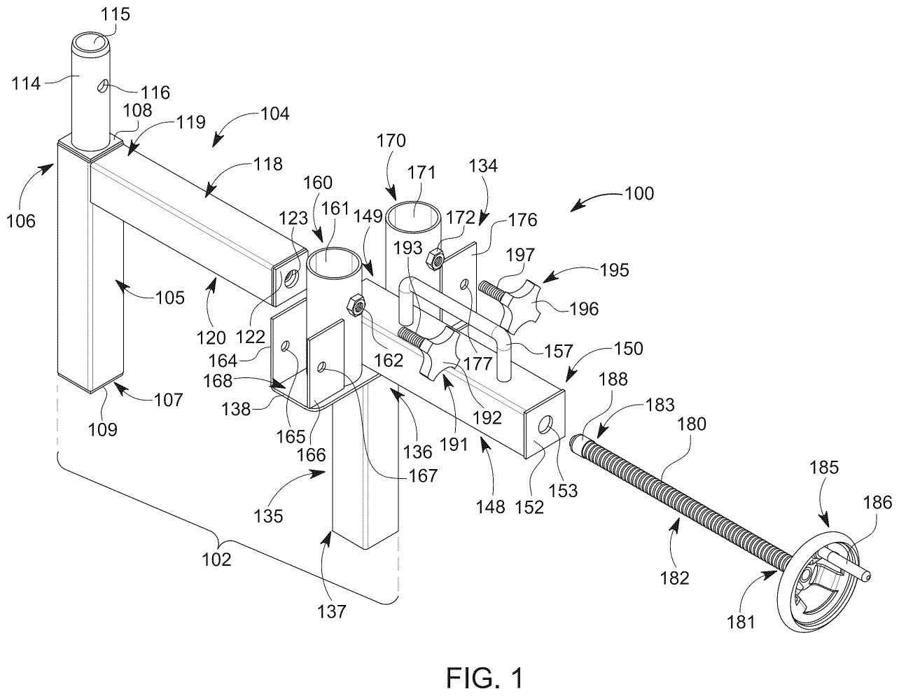

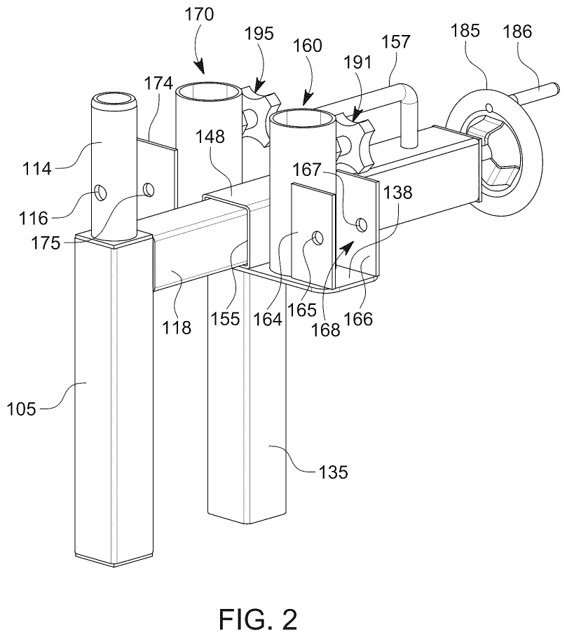

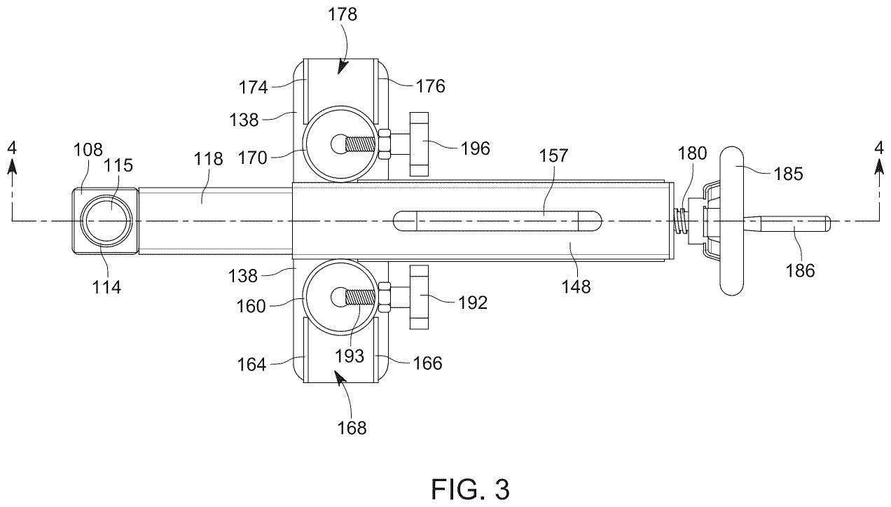

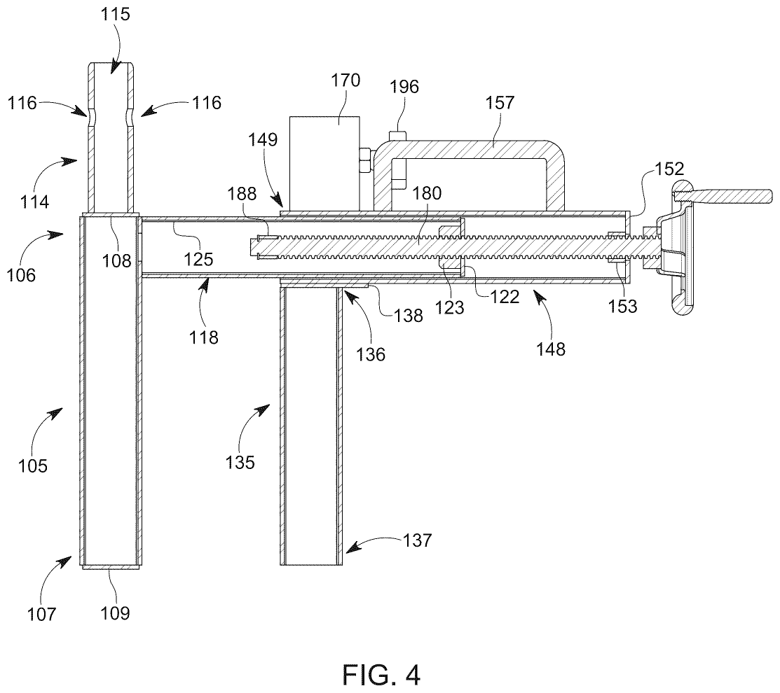

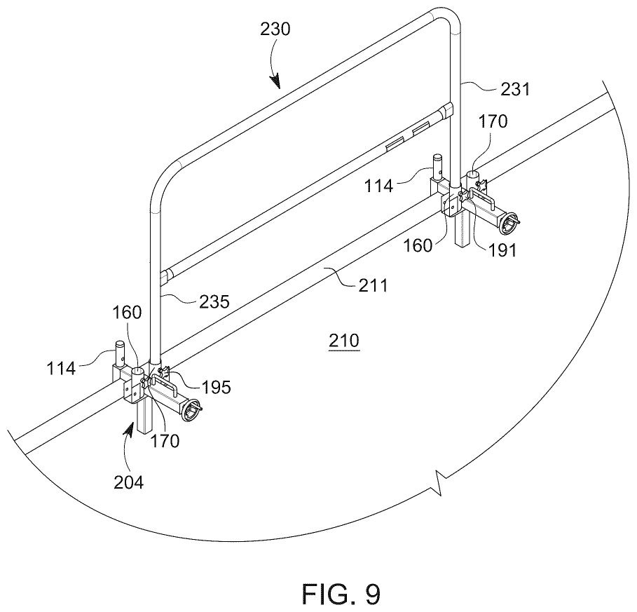

In one embodiment, illustrated in FIGS. 1-13, a trench box or parapet wall guardrail receiver 100 includes a base 102 comprised of a first base portion 104 and a second base portion 134. The first base portion 104 includes a first engaging portion 105 and a first connecting portion 118 extending perpendicularly from each other. The first engaging portion 105 is preferably a square-shaped tube including a proximal end 106 and a distal end 107. An end plate 108 is operatively connected to the proximal end 106 and an end plate 109 is operatively connected to the distal end 107 to close off the open ends of the first engaging portion 105. A male connector 114 is operatively connected to the end plate 108 and extends upward therefrom. The male connector 114 is preferably a cylinder configured and arranged to be inserted into a bore of a safety device. A longitudinal bore 115 extends through the male connector 114, and opposing apertures form a lateral bore 116 extending through opposing sides of the male connector 114. The first connecting portion 118 is preferably a square-shaped tube including a proximal end 119 and a distal end 120. The proximal end 119 is operatively connected to a side of the first engaging portion 105 proximate its proximal end 106. An end plate 122 is operatively connected to the distal end 120 and includes a bore 123, which in this embodiment is a threaded nut operatively connected to the end plate 122 so that its bore aligns with an opening of an aperture in the end plate 122.

The second base portion 134 includes a second engaging portion 135 and a second connecting portion 148 extending perpendicularly from each other. The second engaging portion 135 is preferably a square-shaped tube including a proximal end 136 and a distal end 137. An end plate 138 is operatively connected to the proximal end 136 and extends outward from opposing sides of the second engaging portion 135. The second connecting portion 148 is preferably a square-shaped tube including a proximal end 149 and a distal end 150. The proximal end 149 is operatively connected to the end plate 138 proximate the proximal end 136 of the second engaging portion 135. The second connecting portion 148 forms a longitudinally extending bore 155, which includes an opening proximate the proximal end 149. An end plate 152 is operatively connected to the distal end 150 and includes a bore 153, which in this embodiment is an aperture in the end plate 152. The bore 153 is in communication with the bore 155. The bore 155 is configured and arranged to receive the distal end 120 and a portion of the first connecting portion 118. A handle 157 is operatively connected to a top side of the second connecting portion 148.

A first female connector 160 is operatively connected to the end plate 138 and extends upward therefrom proximate one side of the second connecting portion 148. The first female connector 160 is preferably a cylinder configured and arranged to receive a portion of a safety device. A longitudinal bore 161 extends through the first female connector 160 and a lateral bore 162 extends through a side of the first female connector 160. In this embodiment, the lateral bore 162 is formed by a threaded nut operatively connected to a side of the first female connector 160 so that its bore aligns with an opening of an aperture in the side of the first female connector 160. The lateral bore 162 is configured and arranged to mate with a threaded shaft 193 of a securing member 191. A knob 192 is operatively connected to the threaded shaft 193. A second female connector 170 is operatively connected to the end plate 138 and extends upward therefrom proximate the other side of the second connecting portion 148. The second female connector 170 is preferably a cylinder configured and arranged to receive a portion of a safety device. A longitudinal bore 171 extends through the second female connector 170 and a lateral bore 172 extends through a side of the second female connector 170. In this embodiment, the lateral bore 172 is formed by a threaded nut operatively connected to a side of the second female connector 170 so that its bore aligns with an opening of an aperture in the side of the second female connector 170. The lateral bore 172 is configured and arranged to mate with a threaded shaft 197 of a securing member 195. A knob 196 is operatively connected to the threaded shaft 197.

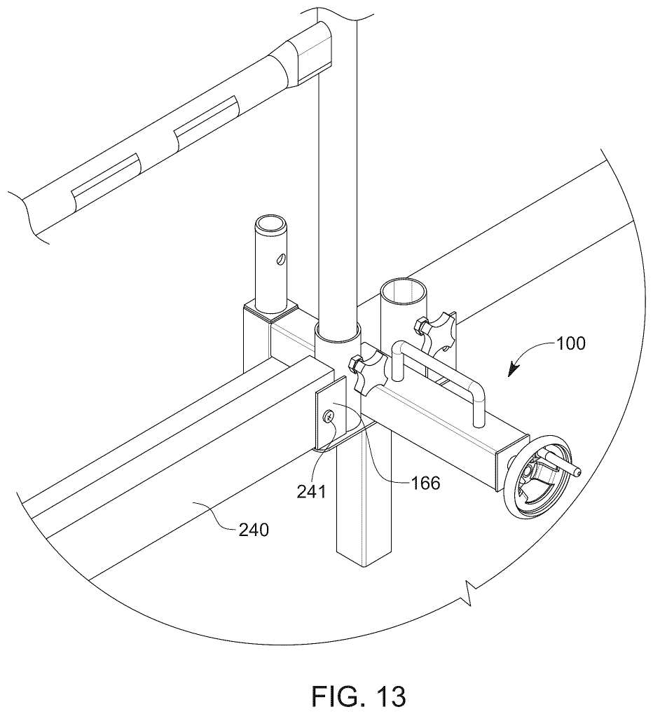

Optionally, the guardrail receiver 100 can be configured and arranged to include a toe board receiver. The toe board receiver includes spaced apart first and second receiving plates forming a channel therebetween configured and arranged to receive a toe board 240, which can be any suitable elongate member such as a 2 inches×4 inches wood board. Proximate a side of the first female connector 160 opposite the second connecting portion 148, a first receiving plate 164 is a generally rectangular plate member including an aperture 165 proximate a middle of the plate 164, and a second receiving plate 166 is also a generally rectangular plate member including an aperture 167 proximate a middle of the plate 166. The plates 164 and 166 form channel 168. In this embodiment, the channel 168 extends perpendicular to the second connecting portion 148. The apertures 165 and 167 are configured and arranged to receive fasteners 241, such as nails or screws, to secure the toe board to the plates 164 and 166. Proximate a side of the second female connector 170 opposite the second connecting portion 148, a first receiving plate 174 is a generally rectangular plate member including an aperture 175 proximate a middle of the plate 174, and a second receiving plate 176 is also a generally rectangular plate member including an aperture 177 proximate a middle of the plate 176. The plates 174 and 176 form channel 178. In this embodiment, the channel 178 extends perpendicular to the second connecting portion 148. The apertures 175 and 177 are configured and arranged to receive fasteners 241, such as nails or screws, to secure the toe board to the plates 174 and 176. One toe board 240 is shown operatively connected to the plates 164 and 166 in FIG. 13. Depending upon the configuration of the guardrail assembly, one or both toe board receivers may be used.

To selectively secure the first and second connecting portions 118 and 148, and thereby the first and second engaging portions 105 and 135, relative to one another in any one of numerous possible positions, a threaded rod 180 extends through the first and second connecting portions 118 and 148. The threaded rod 180 includes an intermediate portion 182 interconnecting a proximal end 181 and a distal end 183. A handle 185 is operatively connected to the proximal end 181, and a handle extension 186 can be used to more efficiently turn the handle 185 thereby rotating the threaded rod 180. The distal end 183 includes a stop 188 so that the threaded rod 180 cannot be removed from the first connecting portion 118. With the first connecting portion 118 inserted into the bore 155 of the second connecting portion 148, and the first connecting portion 118 being slidably connected to the second connecting portion 148, the threaded rod 180 extends through the bores 153 and 155 of the second connecting portion 148 and through the threaded bore 123 of the first connecting portion 118 so that the stop 188 is positioned within the bore 125 of the first connecting portion 118. The portion of the first connecting portion 118 that is received within the bore 155 is variable as it depends upon the desired position of the base portions 104 and 134.

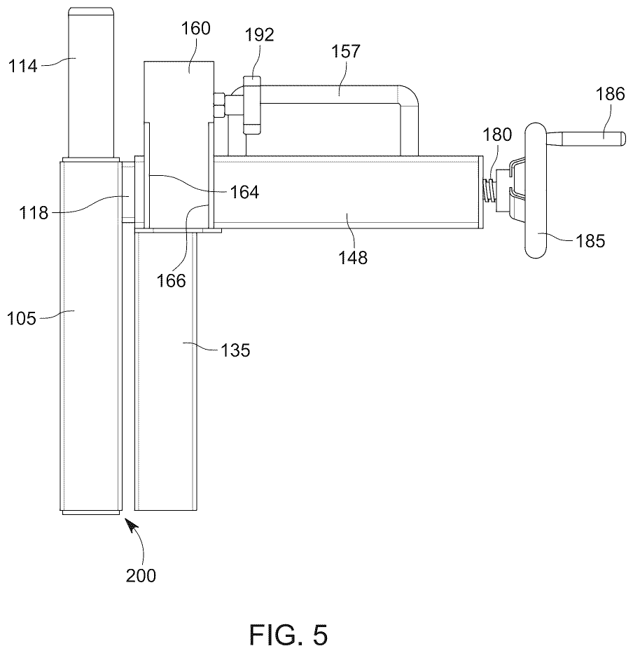

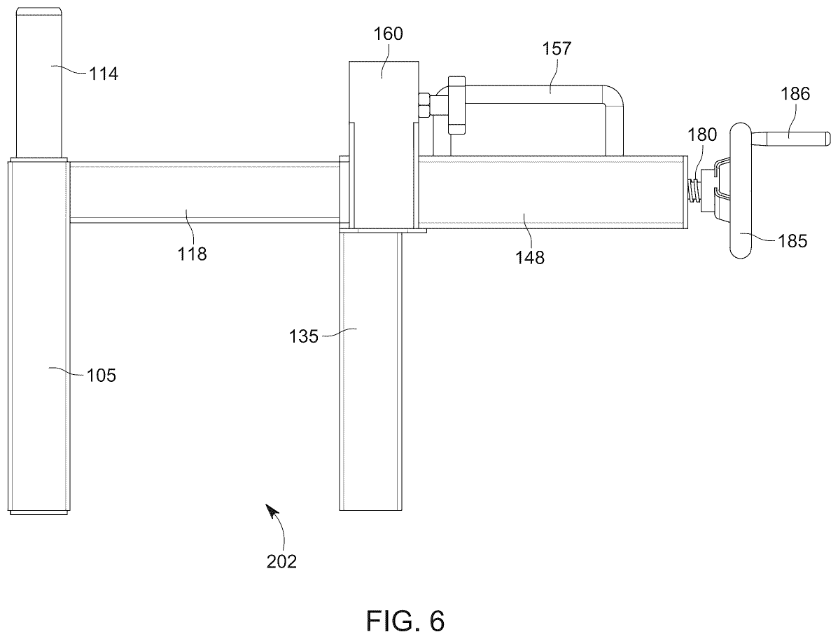

An example closed position 200 is illustrated in FIG. 5, and an example open position 202 is illustrated in FIG. 6. Although a minimal gap is shown between the first and second engaging portions 105 and 135 in FIG. 5, it is recognized that the closed position can include no gap to a minimal gap that is not large enough to receive a trench box or parapet wall. It is recognized that the open position is any position in which a trench box or parapet wall can be received between the first and second engaging portions 105 and 135. The open position can also include an engaging position 204 in which the first and second engaging portions 105 and 135 engage sides of the trench box or parapet wall to secure the guardrail receiver 100 thereto.

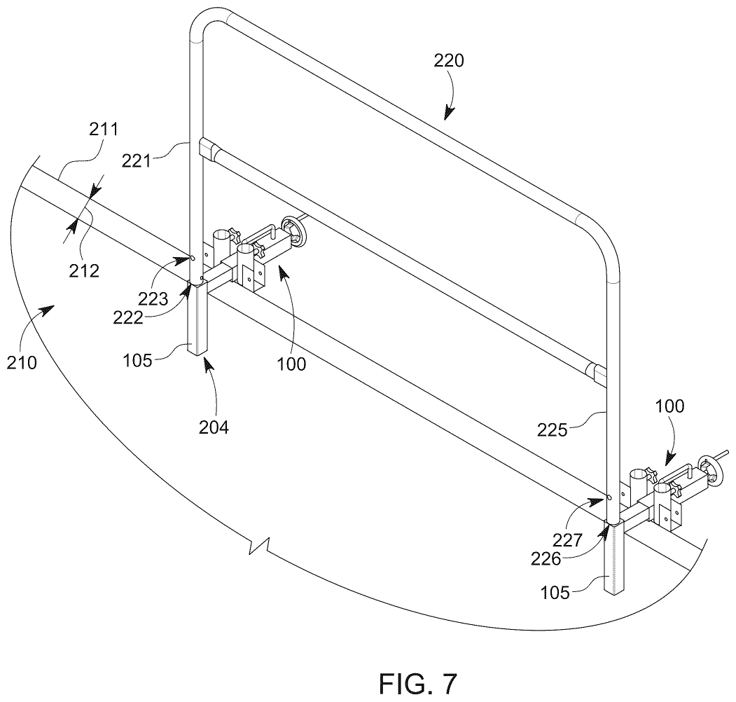

An example trench box or parapet wall 210 is illustrated in FIGS. 7-12. The trench box or parapet wall 210 includes a top 211 and sides defining a width 212. Typically, at least two guardrail receivers 100 are used to connect a guardrail to a trench box or parapet wall 210.

As illustrated in FIG. 7, two guardrail receivers 100 are connected to a trench box or parapet wall 210. Preferably, the guardrail receivers 100 are placed over the tops of the trench box or parapet wall 210 with the handle 185 facing away from the fall hazard. The handle 185 is rotated to bring the first and second engaging portions 105 and 135 closer together to engage the trench box or parapet wall 210, similar to a vice grip. Preferably, a guardrail receiver 100 is positioned every 9 to 10 feet, depending upon the distance between the guardrail posts. In this embodiment, an example guardrail 220 includes a first leg or post 221, which is preferably cylindrical having a longitudinal bore 222 and optionally including an aperture 223, and a second leg or post 225, which is preferably cylindrical having a longitudinal bore 226 and optionally including an aperture 227. The guardrail posts 221 and 225 are configured and arranged to receive the male connectors 114, and fasteners can be inserted through the apertures 223 and 227 of the posts 221 and 225 and through the bores 116 of the connectors 114 to secure the posts to the connectors. A fastener such as a detent pin or a clevis pin with cotter pin could be used. Preferably, the guardrail is positioned so that the guardrail post rungs face away from the fall hazard.

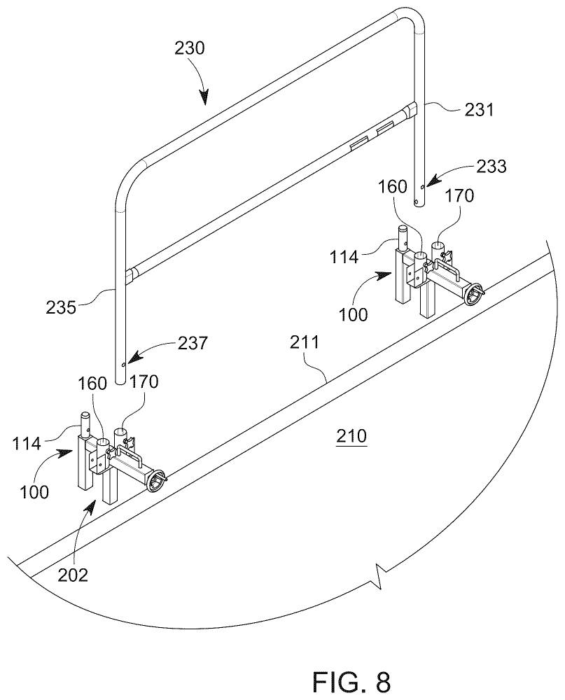

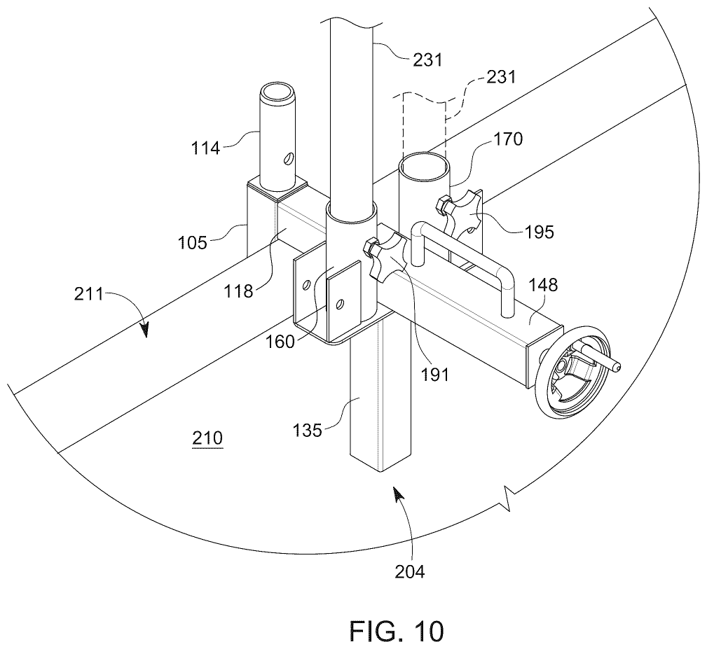

As illustrated in FIGS. 8-10, two guardrail receivers 100 are connected to a trench box or parapet wall 210. In this example, a guardrail 230 includes a first leg or post 231 with an aperture 233 and a second leg or post 235 with an aperture 237. The female connectors 160 and 170 are configured and arranged to receive the posts 231 and 235 within the bores 161 and 171. A guardrail post can be positioned in each of the first and second female connectors. As illustrated in FIG. 10, an optional post 231 is shown in dashed lines received within the second female connector 170. For example, if two guardrails are used, they can be connected using three guardrail receivers or four guardrail receivers. If three guardrail receivers are used, the middle guardrail receiver is connected to both guardrails. To secure the posts 231 and 235 to the connectors 160 and 170, the securing members 191 and 195 extend through the bores 162 and 172 and either push the posts against the opposing inside surface of the connector, like a set screw, or extend through the apertures 233 and 237.

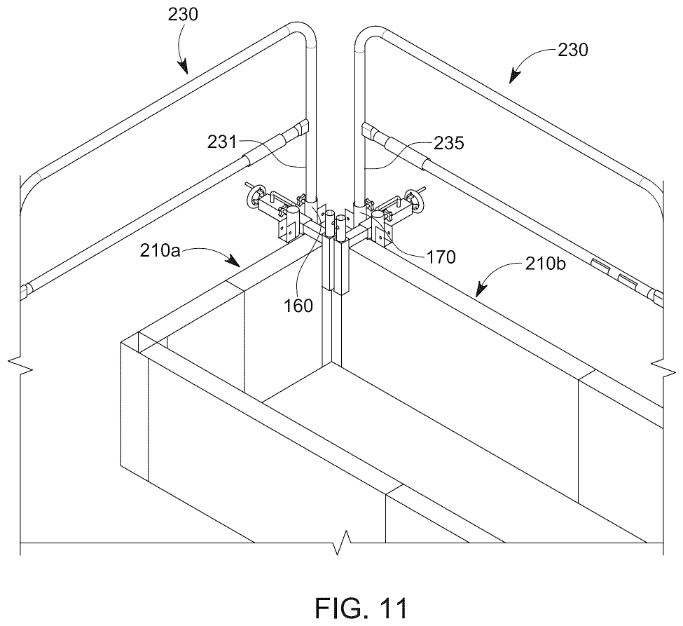

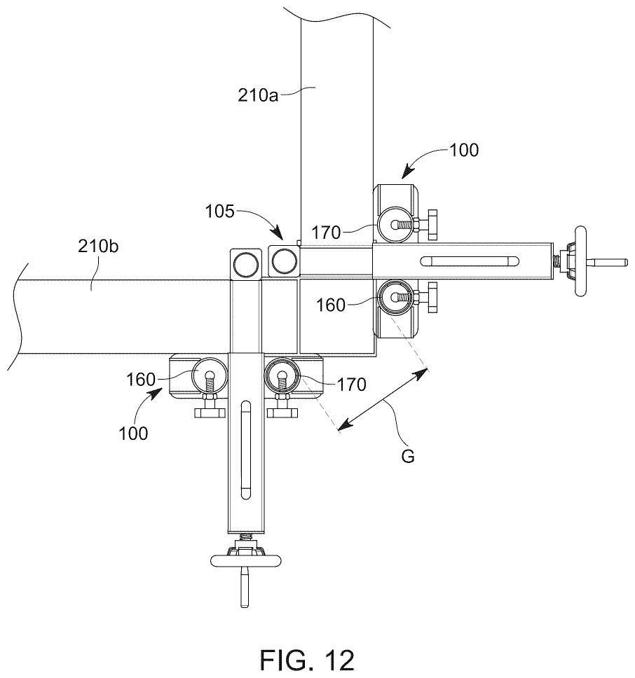

For a corner, as illustrated in FIGS. 11 and 12, a guardrail receiver 100 is positioned on each adjacent wall portion proximate the corner, which in this example is approximately ninety degrees. Preferably, one receiver 100 is positioned on a first wall 210a so that the first engaging portion 105 is positioned in the inner corner, and one receiver 100 is positioned on a second wall 210b so that the first engaging portion 105 is proximate the first engaging portion 105 of the other receiver. When guardrail posts are received within the female connectors proximate the corner, the first and second guardrail receivers are configured and arranged to form a corner gap G of preferably not more than 7.0 inches between outer, inwardly facing surfaces of portions of the guardrail posts received within the female connectors.

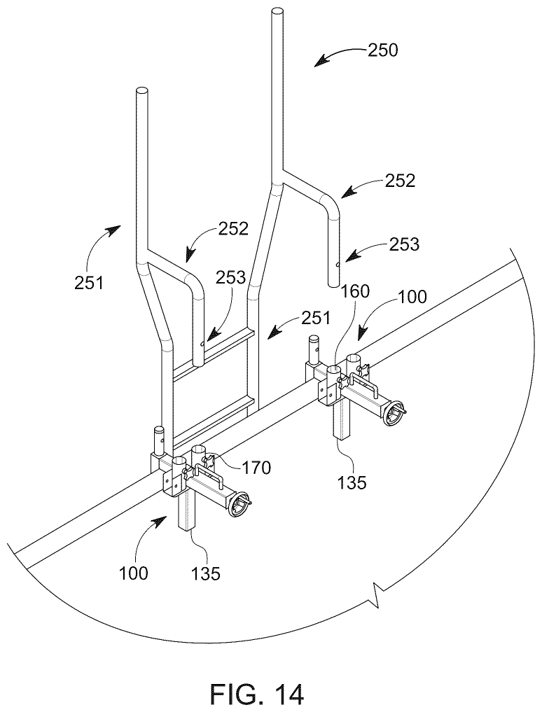

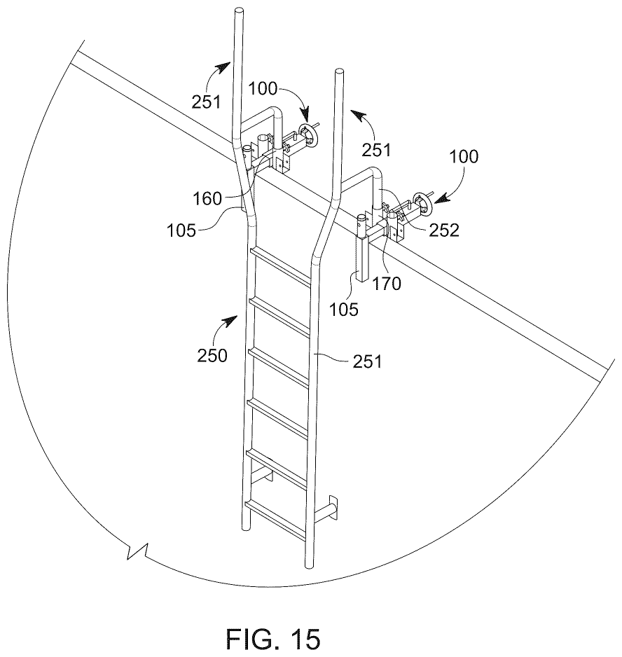

The guardrail receiver 100 can also be connected to a ladder 250, as shown in FIGS. 14 and 15. In this embodiment, the ladder 250 includes rails 251 and returns 252 extending therefrom. Distal ends of the returns 252 include bores 253. The returns 252 are configured and arranged to be operatively connected to the guardrail receivers 100. In this embodiment, the returns 252 are received in the female connectors 160 and 170, and securing members extending through the connectors and into the bores 253 can be used to secure the ladder to the receivers. It is recognized that any suitable ladder can be used, for example, a ladder with each rail including a rail portion, a return, an extension, or a stabilizer configured and arranged to be operatively connected to a connector (female or male) of the receiver.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A guardrail receiver for use with a trench box or parapet wall having sides defining a width, comprising:
a first base portion including a first engaging portion and a first connecting portion extending perpendicularly from each other;
a second base portion including a second engaging portion and a second connecting portion extending perpendicularly from each other, the first and second connecting portions being slidably operatively connected to a desired position to accommodate the width of the trench box or parapet wall, the first and second engaging portions configured and arranged to engage the sides defining the width;
a female connector operatively connected to one of the first base portion or the second base portion;
a male connector operatively connected to one of the first base portion or the second base portion; and
wherein the female and male connectors are configured and arranged to be operatively connected to a variety of safety devices selected from a group consisting of a guardrail leg and a ladder rail, wherein during use one of the female and male connectors is used with one of the guardrail leg or the ladder rail.

2. The guardrail receiver of claim 1, wherein the female connector includes a first female connector and a second female connector.

3. The guardrail receiver of claim 1, wherein the female connector includes a lateral bore configured and arranged to receive a securing member configured and arranged to secure the safety device within the female connector.

4. The guardrail receiver of claim 1, wherein the female connector is operatively connected to the second base portion and the male connector is operatively connected to the first base portion.

5. The guardrail receiver of claim 1, further comprising a toe board connector configured and arranged to receive a toe board.

6. The guardrail receiver of claim 5, wherein the female connector includes a first female connector and a second female connector and the toe board connector includes a first toe board connector and a second toe board connector, and wherein the first and second female connectors and the first and second toe board connectors are operatively connected to the second base portion and the male connector is operatively connected to the first base portion, the first female connector positioned between the second connecting portion and the first toe board connector and the second female connector positioned between the second connecting portion and the second toe board connector.

7. The guardrail receiver of claim 1, wherein the ladder rail includes a rail portion, a return, an extension, or a stabilizer.

8. The guardrail receiver of claim 1, further comprising a threaded rod interconnecting the first connecting portion and the second connecting portion.

9. A guardrail receiver assembly for use with a trench box or parapet wall including walls forming a corner, each wall having sides defining a width, comprising:
a first guardrail receiver comprising:
a first base configured and arranged to engage the sides of a first wall;
a first connector operatively connected to the first base and configured and arranged to be operatively connected to a first safety device selected from the group consisting of a first guardrail leg and a first ladder rail;
a second guardrail receiver comprising:
a second base configured and arranged to engage the sides of a second wall;
a second connector operatively connected to the second base and configured and arranged to be operatively connected to a second safety device selected from the group consisting of a guardrail leg and a ladder rail;
wherein when the first and second guardrail receivers are configured and arranged to be positioned on adjacent walls proximate the corner, positioned approximately ninety degrees relative to each other, the first and second guardrail receivers being configured and arranged to form a corner gap of not more than 7.0 inches between outer, inwardly facing surfaces of portions of the first and second safety devices operatively connected to the first and second connectors.

10. The guardrail receiver assembly of claim 9, wherein each of the first and second bases comprises a first base portion and a second base portion, the first base portion including a first engaging portion and a first connecting portion extending perpendicularly from each other, the second base portion including a second engaging portion and a second connecting portion extending perpendicularly from each other, the first and second connecting portions being slidably operatively connected to a desired position to accommodate the width of the trench box or parapet wall, the first and second engaging portions configured and arranged to engage the sides defining the width; wherein each of the first and second connectors comprises a female connector and a male connector, the female connector is operatively connected to one of the first base portion or the second base portion, the male connector is operatively connected to one of the first base portion or the second base portion, wherein the female and male connectors are configured and arranged to be operatively connected to a variety of safety devices selected from a group consisting of a guardrail leg and a ladder rail, wherein during use one of the female and male connectors is used with one of the guardrail leg or the ladder rail.

11. The guardrail receiver assembly of claim 10, wherein the female connector is operatively connected to the second base portion and the male connector is operatively connected to the first base portion.

12. The guardrail receiver assembly of claim 10, further comprising a toe board connector configured and arranged to receive a toe board.

13. The guardrail receiver assembly of claim 12, wherein the female connector includes a first female connector and a second female connector and the toe board connector includes a first toe board connector and a second toe board connector, and wherein the first and second female connectors and the first and second toe board connectors are operatively connected to the second base portion and the male connector is operatively connected to the first base portion, the first female connector positioned between the second connecting portion and the first toe board connector and the second female connector positioned between the second connecting portion and the second toe board connector.

14. The guardrail receiver assembly of claim 10, further comprising a threaded rod interconnecting the first connecting portion and the second connecting portion.

15. The guardrail receiver assembly of claim 9, wherein the ladder rail includes a rail portion, a return, an extension, or a stabilizer.

16. The guardrail receiver assembly of claim 9, wherein the first and second connectors are each selected from the group consisting of a female connector and a male connector, the first and second connectors being configured and arranged to be operatively connected to the respective first or second safety device, wherein during use one of the first and second connectors is used with one of the safety devices.

17. The guardrail receiver assembly of claim 16, wherein the female connector includes a first female connector and a second female connector.

18. The guardrail receiver assembly of claim 16, wherein the female connector includes a lateral bore configured and arranged to receive a securing member configured and arranged to secure the safety device within the female connector.
